(19) United States
(12) Patent Application Publication
(10) Pub. No.: US 2025/0344259 A1
(43) Pub. Date: Nov. 6, 2025

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventor: Lantao LI, Beijing (CN)

(73) Assignee: Sony Group Corporation, Tokyo (JP)

(21) Appl. No.: 18/869,906

(22) PCT Filed: Jun. 5, 2023
(86) PCT No.: PCT/CN2023/098221

§ 371 Date: Nov. 27, 2024

(30) Foreign Application Priority Data
Jun. 10, 2022 (CN) 202210654415.5

(51) Int. Cl. H04W 76/10; H04W 4/06; H04W 28/18

(52) U.S. Cl. CPC H04W 76/10; H04W 4/06; H04W 28/18

(57) ABSTRACT

Provided in the present disclosure are an electronic device and method for wireless communication, and a computer-readable storage medium. The electronic device comprises a processing circuit, which is configured to send to one or more second terminal devices service information of a service that a first terminal device can provide, the service information comprising service type information and service characteristic information, and is configured to provide a data stream of a corresponding service to at least one terminal device among the one or more second terminal devices on the basis of the service information.

The present application claims priority to Chinese Patent Application No. 202210654415.5, titled “ELECTRONIC DEVICE AND METHOD FOR WIRELESS COMMUNICATION, AND COMPUTER-READABLE STORAGE MEDIUM”, filed on Jun. 10, 2022 with the China National Intellectual Property Administration, which is incorporated herein by reference in its entirety.

### FIELD

The embodiments of the present disclosure generally relate to the technical field of wireless communications, and in particular to enhancement of short-range communication networks. More specifically, the embodiments of the present disclosure relate to an electronic apparatus for wireless communications, a method for wireless communications, and a computer-readable storage medium.

### BACKGROUND

For the enhancement of communications based on proximity services (ProSe), currently the 3GPP of version Rel-17 (TS23.304) is only confined to a user equipment to a network relay (UE-to-Network Relay), and does not relate to a user equipment to a user equipment relay (UE-to-UE Relay), and both are PC5 connections based on unicast links.

In scenarios such as the Internet of vehicles (V2X), intelligent robots, and drones, broadcasting and groupcast that are based on PC5 connections are main communication modes for supporting services, such as message push for security applications and efficiency applications, and especially for applications related to vehicle road collaboration. However, the range of communication services that a single terminal device can provide based on broadcast and groupcast is limited, so that it is required to enhance communication modes such as broadcast and groupcast.

Currently, broadcast is performed based on a mapping relationship between a single service and a destination Layer-2 ID. The data packet transmitting the UE broadcast is transmitted via broadcast after carrying the destination Layer-2 ID, without any forwarding mechanism or satisfaction of customized requirements for this service and applications of HARQ and beam.

Groupcast may include the following two types: one type is broadcast-like groupcast, which has a form of broadcast but carries groupcast services, and the other type is groupcast with upper level group management. The upper level group management may transmit the number of group members, group IDs, communication ranges and the like to the non-access stratum (NAS), facilitating the NAS to perform additional functions such as managing group members, generating a destination Layer-2 ID for specific group communications, and providing HARQ feedbacks.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

According to an aspect of the present disclosure, an electronic apparatus for wireless communications is provided. The electronic apparatus includes processing circuitry. The processing circuitry is configured to: transmit service information of services that can be provided by a first terminal device to one or more second terminal devices, where the service information includes service type information and service characteristic information; and provide, based on the service information, a data stream of a corresponding service to at least one terminal device among the one or more second terminal devices.

According to another aspect of the present disclosure, a method for wireless communications is provided. The method includes: transmitting service information of services that can be provided by a first terminal device to one or more second terminal devices, where the service information includes service type information and service characteristic information; and providing, based on the service information, a data stream of a corresponding service to at least one terminal device among the one or more second terminal devices.

According to the electronic apparatus and the method in the above aspects of the present disclosure, service data with finer granularities can be provided to better adapt to the customization requirements.

According to an aspect of the present disclosure, an electronic apparatus for wireless communications is provided. The electronic apparatus includes processing circuitry. The processing circuitry is configured to: receive, from a second terminal device, service information of services that can be provided by the second terminal device, where the service information includes service type information and service characteristic information; and include the service information in providing information of data services that can be provided by a first terminal device and multicast the providing information to one or more third terminal devices.

According to another aspect of the present disclosure, a method for wireless communications is provided. The method includes: receiving, from a second terminal device, service information of services that can be provided by the second terminal device, where the service information includes service type information and service characteristic information; and including the service information in providing information of data services that can be provided by a first terminal device and multicasting the providing information to one or more third terminal devices.

According to the electronic apparatus and the method in the above aspects of the present disclosure, relay transmission of service data with finer granularities can be achieved, to better adapt to the customization requirements and enhance the coverage in multicast communication mode.

According to an aspect of the present disclosure, an electronic apparatus for wireless communications is provided. The electronic apparatus includes processing circuitry. The processing circuitry is configured to: receive, from a second terminal device, providing information of data services that can be provided by the second terminal device, which is transmitted by the second terminal device via multicast, where the providing information includes service information of services that can be provided, and the service information includes service type information and service characteristic information; and transmit a service trigger request of a first terminal device to the second terminal device, where the service trigger request includes requirement information of a service characteristic of the first terminal device.

According to another aspect of the present disclosure, a method for wireless communications is provided. The method includes: receiving, from a second terminal device, providing information of data services that can be provided by the second terminal device, which is transmitted by the second terminal device via multicast, where the providing information includes service information of services that can be provided, and the service information includes service type information and service characteristic information; and transmitting a service trigger request of a first terminal device to the second terminal device, where the service trigger request includes requirement information of a service characteristic of the first terminal device.

According to the electronic apparatus and the method in the above aspects of the present disclosure, service data with finer granularities can be obtained to better adapt to the customization requirements and enhance the coverage in multicast communication mode.

According to an aspect of the present disclosure, an electronic apparatus for wireless communications is provided. The electronic apparatus includes processing circuitry. The processing circuitry is configured to: perform beam matching for one or more second terminal devices to select a beam to be used in communications; and perform communication between a first terminal device and the one or more second terminal devices using the selected beam.

According to another aspect of the present disclosure, a method for wireless communications is provided. The method includes: performing beam matching for one or more second terminal devices to select a beam to be used in communications; and performing communications between a first terminal device and the one or more second terminal devices using the selected beam.

According to the electronic apparatus and the method in the above aspects of the present disclosure, directional data transmission is achieved by performing beam matching, improving the communication efficiency.

According to other aspects of the present disclosure, a computer program code and a computer program product for implementing the method for wireless communications mentioned above, and a computer-readable storage medium having the computer program code for implementing the method for wireless communications stored thereon are provided.

These and other advantages of the present disclosure will be more apparent from the following detailed description of preferred embodiments of the present disclosure in conjunction with the accompanying drawings.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure. In the accompanying drawings:

FIG. 1 shows a functional block diagram of an electronic apparatus for wireless communications according to an embodiment of the present disclosure;

FIG. 2 shows a functional block diagram of an electronic apparatus for wireless communications according to another embodiment of the present disclosure;

FIG. 3 shows an example of phase matching in a scenario of internet of vehicles;

FIG. 4 shows an example of relevant information flows between a service UE, a relay UE, and a remote UE;

FIG. 5 shows an example of information flows of a fourth terminal device joining an existing network;

FIG. 6 shows an example of phase matching for a new relay UE joining a network in a scenario of internet of vehicles;

FIG. 7 shows an example of phase matching for a new service UE joining a network in a scenario of internet of vehicles;

FIG. 8 shows a schematic example of beam direction limitation;

FIG. 9 shows a schematic example of interactions of maintaining an active signaling;

FIG. 10 shows another schematic example of interactions of maintaining an active signaling;

FIG. 11 shows a functional block diagram of an electronic apparatus for wireless communications according to another embodiment of the present disclosure;

FIG. 12 shows a functional block diagram of an electronic apparatus for wireless communications according to another embodiment of the present disclosure;

FIG. 13 shows an example of a beam matching process;

FIG. 14 shows another example of a beam matching process;

FIG. 15 shows another example of a beam matching process;

FIG. 16 shows a flowchart of a method for wireless communications according to an embodiment of the present application;

FIG. 17 shows a flowchart of a method for wireless communications according to another embodiment of the present application;

FIG. 18 shows a flowchart of a method for wireless communications according to another embodiment of the present application;

FIG. 19 shows a flowchart of a method for wireless communications according to another embodiment of the present application;

FIG. 20 is a block diagram showing an example of a schematic configuration of a smartphone to which the technology according to the present disclosure may be applied;

FIG. 21 is a block diagram showing an example of a schematic configuration of a car navigation apparatus to which the technology according to the present disclosure may be applied; and

FIG. 22 is a block diagram of an exemplary block diagram illustrating the structure of a general purpose personal computer capable of realizing the method and/or device and/or system according to the embodiments of the present disclosure.

### DETAILED DESCRIPTION OF EMBODIMENTS

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a service, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

As mentioned above, it is expected to provide an enhancement technology for short-range communications between terminal devices, especially an enhancement technology for the groupcast communication mode or broadcast communication mode. In following description, groupcast and broadcast may be collectively referred to as multicast. In addition, in part of the following description, the scenario of internet of vehicles is to be used as an example, but it should be understood that this is not restrictive, but only for the convenience of description. The terms of “first”, “second”, “third”, “fourth” and the like in this specification are used only for distinguishing, and do not represent any other meaning such as order or priority.

### First Embodiment

FIG. 1 shows a functional block diagram of an electronic apparatus 100 for wireless communications according to an embodiment of the present disclosure. As shown in FIG. 1, the electronic apparatus 100 includes: a transceiving unit 101 and a providing unit 102. The transceiving unit 101 is configured to transmit service information of services that can be provided by a first terminal device to one or more second terminal devices. The service information includes service type information and service characteristic information. The providing unit 102 is configured to provide, based on the service information, a data stream of a corresponding service to at least one terminal device among the one or more second terminal devices.

The transceiving unit 101 and the providing unit 102 may be implemented by one or more processing circuitries, and the processing circuitry, for example, may be implemented as a chip or a processor. Moreover, it should be understood that, the functional units in the electronic apparatus shown in FIG. 1 are only logic modules which are divided based on the specific functions thereof, and are not intended to limit the specific implementations.

The electronic apparatus 100, for example, may be arranged on a first terminal device or may be communicatively connected to a first terminal device. The terminal devices described in this specification, for example, may be various user equipments, and the terminal device is represented as UE in the following descriptions. For example, the terminal device may be implemented as a mobile terminal (such as a smart phone, a tablet personal computer (PC), a notebook PC, a portable game terminal, a portable/dongle type mobile router, and a digital camera device), or an in-vehicle terminal (such as a car navigation device). The terminal device may also be implemented as a terminal that performs machine-to-machine (M2M) communication (which is also referred to as a machine type communication (MTC) terminal). Furthermore, the terminal device may be a wireless communication module (such as an integrated circuit module including a single wafer) mounted on each of the terminals.

It should be further noted that the electronic apparatus 100 may be implemented at a chip level or a device level. For example, the electronic apparatus 100 may function as a first terminal device itself, and may further include an external device such as a memory and a transceiver (not shown in FIG. 1). The memory may store programs and related data information required for implementing various functions by the electronic apparatus. The transceiver may include one or more communication interfaces to support communication with different devices (for example, other terminal devices, a base station or the like). The implementation of the transceiver is not limited herein.

In the embodiment, the first terminal device may provide a data stream of a type of service to other terminal devices, and thus the first terminal device may be referred to as a service UE or an information source in the following description. For example, the first terminal device may provide: capability of perception of a specific region, such as providing various data of sensors, and the sensors include lidars, radars, camera devices, meteorological sensors, and the like; target information in the specific region, such as information of locations and movement speeds of vehicles, pedestrians, and aircrafts; a map information service, such as construction of 2D or 3D maps; a task information release service, such as requirement task release for automatic guided transport vehicles (AGVs) to transport goods; and parameter update in deploying or training an artificial intelligence/machine learning (AI/ML) model, such as reporting of training iteration results and model parameter updating in distributed learning or federated learning.

In order to inform other terminal devices of the types of services that the first terminal device can provide, the first terminal device may include service type information in the service information for provision. For example, the service type information may indicate but is not limited to one or more of the above types. The service type information may be indicated by a service identification (ID), and the service identification may be standardized. Alternatively, the service type information may be in a form of literal descriptive information, which is not limited.

Furthermore, the service information may further include service characteristic information. The service characteristic information indicates indicating information of a characteristic of a service of one or more granularities under the type of the corresponding service. For example, the service characteristic information may include: a service characteristic identification (ID), service characteristic differentiation information, a directional or regional transmission requirement, and relay transmission related information. The service characteristic ID is used to uniquely indicates a service characteristic with a finer granularity under a corresponding type of service, such as indicating the type of a specific sensor in a case that the type of service is the sensing capability for a specific region. In addition, the service characteristic ID may be unique in the range of a local mesh network.

The service characteristic differentiation information is used for distinguishing content of different characteristics in service content of a corresponding type of service. For example, the service characteristic differentiation information includes one or more of: a geographic range involved in service data, service source information/sensor information, and a map resolution. The sensor information includes, for example, the type of a sensor, and a location of the sensor such as source coordinates, a direction, and a field of view (FOV). In this way, the sensor data or other source data may be shared, facilitating fusion requirement matching and alignment correction in data fusion perception process of sensors or other sources.

The directional or regional transmission requirement is used for further limiting the service content, and may include a transmission requirement for a specific direction or a transmission requirement for a specific region. For example, for two lanes away from an intersection, vehicle information on one lane may not be meaningful for the other lane, and thus it is only required to provide vehicle information on one lane.

The relay transmission related information may include one or more of: a transmission range of service data, whether relay transmission can be performed, a directional or regional transmission requirement for the relay transmission, a hop limit of the relay transmission, and a service reliability requirement. The service reliability requirement, for example, includes whether alternative communication paths are required and QoS of relays.

In addition, the service information may further include a transmission mode of a data stream carrying the services. The transmission mode includes broadcast, groupcast, or unicast.

By transmitting the service information of the services that can be provided by the first terminal device to one or more second terminal devices, the terminal devices having related service requirements can be facilitated to obtain corresponding service content with a desired granularity from the first terminal device. A second terminal device may determine, based on the capability of the second terminal device itself such as whether the second terminal device has the ability to forward service, whether to save the received service information and maintain connection confirmation with the service UE, that is, whether the second terminal device serves as a relay UE.

The transceiving unit 101 may transmit the above service information in at least one transmission mode of broadcast, groupcast and unicast through a PC5 port.

Correspondingly, the providing unit 102 may provide, in response to a requirement of at least one second terminal device, a data stream of a corresponding service to the at least one second terminal device based on the service information. The second terminal device may be a relay UE, or a remote UE which is a non-relay UE.

In addition, the providing unit 102 may further be configured to mark a data packet in the data stream of the corresponding service based on the service characteristic information, and then transmit the data packet. The providing unit 102 may mark the data packet by one of: marking a specific field in a header of the data packet in a specific transport protocol layer included in a transport protocol stack; or modulating data in the data packet in a modulation mode corresponding to the service characteristic information and then transmitting; or transmitting the data packet in a time period corresponding to the service characteristic information. In this way, the second terminal device may recognize data packets with corresponding service characteristics.

In addition, the transceiving unit 101 may further be configured to provide phase information of the first terminal device to the second terminal devices. The phase information includes one or more of geographic location information of the first terminal device, mobility information of the first terminal device, and path planning information of the first terminal device.

Due to the possibility that both the first terminal device and the second terminal device are in a mobile state, the actual link between the first terminal device and the second terminal device may constantly changes. In order to provide stable data services, it is expected that the first terminal device and the second terminal device have similar motion characteristics. For example, the similarity of motion characteristics of the first terminal device and the second terminal device may be evaluated based on a matching degree of phase information of the first terminal device and phase information of the second terminal device.

For example, the matching of phase information of two terminal devices may be performed based on the following equation:

$$D = w 1 ⋆ d 1 + w 2 ⋆ d 2 + w 3 ⋆ d 3 \qquad ( 1 )$$

where d1 represents an Euclidean distance between the two terminal devices, d2 represents a difference between speeds of the two terminal devices, d3 represents a percentage of overlap between planned paths or expected paths of the two terminal devices, and w1, w2 and w3 represent weight coefficients of respective items.

The matching of phase information may be performed by the second terminal device or by the first terminal device, which is not limited. For example, when the second terminal device determines that the matching degree of the phase information of the first terminal device and the phase information of the second terminal device is above a predetermined threshold, the second terminal device requests data transmission of a specific service to the first terminal device.

In addition to the phase information mentioned above, the matching process may further take the transmission and reception capability of the second terminal device into consideration. The transmission and reception capability may be indicated by numerical values. For example, distributed antennas are arranged on a large vehicle. That is, transmitting and receiving antennas are arranged on the vehicle body at different heights and in different directions. Compared to a small vehicle with a single antenna/centralized antenna, the distributed antennas have stronger data transmission and reception capability and a space angle range for establishing short-range communication links. Therefore, as relay nodes, the distributed antennas have stronger data transmission and reception capability and continuity of short-range communication links.

In an example, the second terminal device serves as a relay device and is configured to transmit the data stream to one or more third terminal devices (which are also called as remote terminal devices or remote UEs). The relay device herein may be a single relay device or a local D2D network formed by multiple relay devices. The transceiving unit 101 may further be configured to transmit, in response to service content requirement information from a second terminal device, a networking request to the second terminal device. The networking request includes the service information and the phase information of the first terminal device. The service content requirement information, for example, includes descriptions of specific service types and service characteristics or descriptions of coverage requirements in a certain direction, to request peripheral terminal devices that have not joined the network to join the network to provide corresponding services or expand the coverage area of existing services. For example, in a case that the phase information of the first terminal device matches the relay device and/or the remote terminal device, the first terminal device may join the network and provide services.

In addition, the transceiving unit 101 may further transmit a networking request, in response to a request from an application layer. In some cases, there may be no existing local mesh network, that is, the first terminal device initiates the establishment of the local mesh network, which is not limited.

The electronic apparatus 100 according to the embodiment may provide service data with finer granularities to better adapt to customization requirements. In addition, the electronic apparatus 100 may enable the first terminal device to join an existing local mesh network or initiate a networking request to expand the coverage area of the service initially.

### Second Embodiment

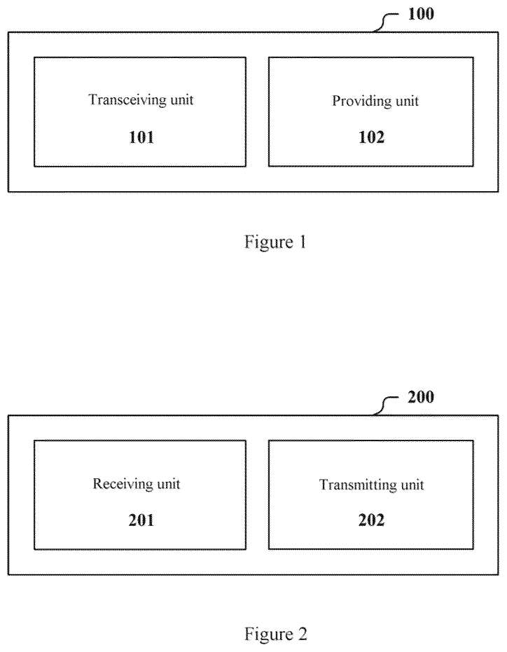

FIG. 2 shows a functional block diagram of an electronic apparatus 200 according to another embodiment of the present disclosure. As shown in FIG. 2, the electronic apparatus 200 includes: a receiving unit 201 and a transmitting unit 202. The receiving unit 201 is configured to receive, from a second terminal device, service information of services that can be provided by the second terminal device. The service information includes service type information and service characteristic information. The transmitting unit 202 is configured to include the service information in providing information of data services that can be provided by a first terminal device and multicast the providing information to one or more third terminal devices.

The receiving unit 201 and the transmitting unit 202 may be implemented by one or more processing circuitries, and the processing circuitry, for example, may be implemented as a chip or a processor. Moreover, it should be understood that, functional units in the electronic apparatus shown in FIG. 2 are only logic modules which are divided based on the specific functions thereof, and are not intended to limit the implementations.

The electronic apparatus 200, for example, may be arranged on a first terminal device or may be communicatively connected to a first terminal device.

It should be further noted that the electronic apparatus 200 may be implemented at a chip level or a device level. For example, the electronic apparatus 200 may function as a first terminal device itself, and may include an external device such as a memory and a transceiver (not shown in FIG. 2). The memory may store programs and related data information required for implementing various functions by the electronic apparatus. The transceiver may include one or more communication interfaces to support communication with different devices (for example, other terminal devices, a base station or the like). The implementation of the transceiver is not limited herein.

For example, the receiving unit 201 may receive the service information in at least one transmission mode of broadcast, groupcast and unicast through a PC5 port.

The service information in this embodiment has the same meaning as the service information described in the first embodiment. For example, the service type information indicates a type of a service provided by the second terminal device, and the service characteristic information indicates indicating information of a characteristic of a service of one or more granularities under the type of the service. The type of service, for example, includes: perception of a specific region, providing target information in the specific region, a map information service, a task information release service, and parameter updating in deploying or training an artificial intelligence/machine learning model. The service characteristic information may include one or more of: a service characteristic ID, service characteristic differentiation information, a directional or regional transmission requirement, and relay transmission related information. The service characteristic differentiation information may include one or more of: a geographic range involved in service data, service source information/sensor information, and a map resolution. For example, the directional or regional transmission requirement includes a transmission requirement for a specific direction or a transmission requirement for a specific region. The relay transmission related information includes one or more of: a transmission range of service data, whether relay transmission can be performed, a directional or regional transmission requirement of the relay transmission, a hop limit of the relay transmission, and a service reliability requirement. In addition, the service information may further include a transmission mode of a data stream carrying the corresponding service. Related details may be referred to the descriptions in the first embodiment, and are not repeated herein.

The transmitting unit 202 may be configured to: include, in a case that the relay transmission related information indicates that the relay transmission can be performed, the service information in the providing information, and multicast the providing information to the one or more third terminal devices. Apparently, it may be assumed that the multicast can be performed by default.

In this way, the first terminal device operates as a relay UE, the second terminal device operates as a service UE (information source), and the third terminal device operates as a remote UE (also called an initiating UE). The service UE, the relay UE, and the remote UE form a local mesh network. The data service that can be provided by the first terminal device includes the data service currently being provided and an available data service, such as a data service forwarded to the first terminal device through other online nodes (including the service UE and other relay UEs). By including information of data services that can be provided by the first terminal device in the providing information and providing the providing information to multiple third terminal devices, a third terminal device having a corresponding data requirement may be enabled to obtain the data service through a relay.

In addition to the information of the data services that can be provided by the first terminal device, the providing information may further include phase information of the first terminal device. As mentioned above, the phase information includes one or more of geographic location information of a terminal device, mobility information of a terminal device, and path planning information of a terminal device.

Due to the mobility of the relay UE, the actual link between the relay UE and the remote UE constantly changes. Specifically, the received signal strength changes, which affects the continuity of service after the remote UE accesses into the network. Therefore, the relay UE may provide phase information, so that phase matching may be performed between the relay UE and the remote UE. Detail examples of phase matching are described in the first embodiment, and are not repeated herein. Phase matching may be performed at the relay UE or at the remote UE, which is not limited. For example, in a case that the phase of the relay UE matches the phase of the remote UE, a connection is established between the relay UE and the remote UE.

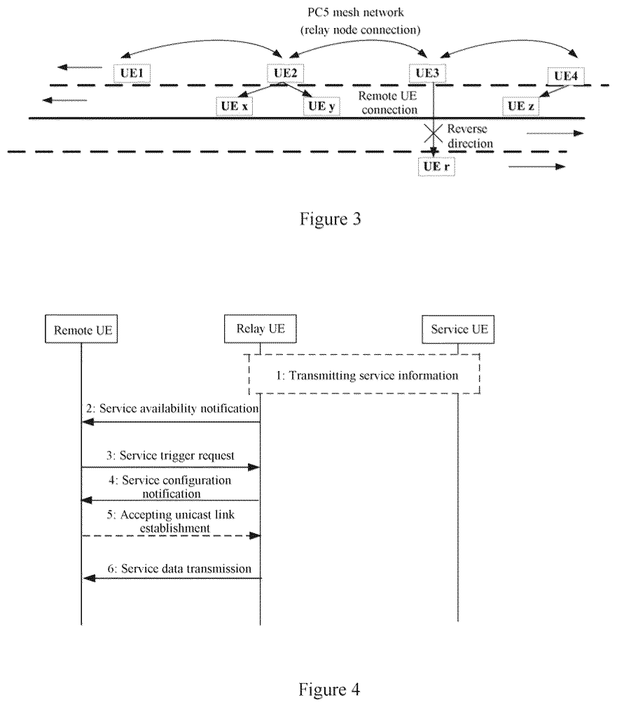

For ease of understanding, FIG. 3 shows an example of phase matching in a scenario of internet of vehicles. In FIG. 3, UE 1 to UE 4 are relay UEs, and are interconnected to form a PC5 mesh network. UE x, UE y, UE z, and UE r are remote UEs. The movement direction of UE r is opposite to the movement direction of the relay UEs. Therefore, the phase of UE r does not match the phase of relay UE 3, and a connection between UE r and UE 3 cannot be established.

The receiving unit 201 is further configured to receive, from a third terminal device, a service trigger request, and match the service trigger request with the data services that can be provided by the first terminal device. The service trigger request includes requirement information of a service characteristic of the third terminal device. The transmitting unit 202 is configured to provide, in a case that the requirement information matches the data services that can be provided by the first terminal device, a data service to the third terminal device.

The requirement information of the service characteristic, for example, includes a geographic range involved in the required service data, service source information/sensor information, a map resolution and the like. In fact, the perfect match between the requirement information and the data services that can be provided by the first terminal device is a low-probability event. Therefore, the requirement information may be set as representations of some points, and the data services that can be provided by the first terminal device may be representations of a range, as long as the former can fall within the range of the latter. For example, in a case that the service characteristic indicates a geographical range, the service characteristic information in the requirement information may be geographical locations of some target points, and the first terminal device provides a regional range, as long as the geographical locations of the target points are located in the provided regional range. Similarly, in other types of service, similar comparison may be performed. For example, the first terminal device may provide a parameter update range of a particular layer in an AI/ML model, or an operation regional range corresponding to a task of a robot or a drone, or the like.

In addition, the service trigger request may further include one or more of: a QoS requirement for service data transmission (such as a multi-hop number limit and a service continuity requirement), a transmission mode type requirement (whether the transmission between the first terminal device and the third terminal device is broadcast, groupcast, or unicast), and phase information of the third terminal device. The receiving unit 201 is further configured to perform matching between these requirements or information to comprehensively determine whether the first terminal device may provide a data service for the third terminal device. For example, the receiving unit 201 may perform matching of phase information as described above, and do not provide the data service to the third terminal device in a case of phase information mismatch. Similarly, the receiving unit 201 may further take a QoS requirement and a transmission mode type requirement of the third terminal device into consideration while performing matching of data services.

The transmitting unit 202 may provide the data service to the third terminal device, for example, by one of: adding the third terminal device to a subscription group for a data service with exactly matched content which is being provided by the first terminal device; newly adding a data service that meets a requirement of the third terminal device, and adding the third terminal device to a subscription group for the newly added data service; and establishing a unicast data service of the first terminal device for the third terminal device.

Specifically, in a case that the first terminal device already provides data services in the form of broadcast or groupcast with completely identical service characteristics to other terminal devices, it is only required for the first terminal device to add the third terminal device as a new subscription remote UE for the data services. In this case, it substantially does not relate to modifying a QoS rule or a corresponding packet filter, and it may be required to update the number of group members and range parameters in the case of groupcast.

In a case that the first terminal device has not provided data services that meet the requirements (including a case that the required service characteristic does not exist at all and a case that the required service characteristic does not fully correspond thereto), it is required for the first terminal device to firstly add configurations for corresponding data services from other relay UEs or service UEs, for example, including determining data transmission of related service characteristics on the data plane, determining modifications of the QoS rule of the data plane of the first terminal device and forwarding packet filters, and adding a third interrupt device to the subscription group of the newly added data service.

In addition, the first terminal device may further establish a unicast carrying service data stream for the third terminal device, that is, provide a unicast data service. In a unicast establishment/modification process, the first terminal device and the third terminal device mutually confirm modification of QOS rules and packet filters. It should be noted that although the first terminal device and the third terminal device perform communications in the form of unicast in this case, the data source forwarded by the first terminal device may be in the form of multicast. That is, the service data generated by the information source not only serves a remote UE.

After ensuring that the process in the data plane is ready, the first terminal device transmits confirmation information to the third terminal device. For example, the confirmation information includes a QoS rule/a packet filter/a destination address (L2 or L3 destination/source ID) information for transmitting and receiving the data stream. The confirmation information may further include an ID of a newly added service characteristic under a certain service type of the third terminal device. For example, in a case that a service data stream of original relay broadcast of the first terminal device includes shared data/target recognition information of some sensors and the third terminal device adds a new service characteristic requirement (such as information about a lane to be turned into) that does not belong to the current data stream but belongs to information set that can be provided by the service UE, it is required to include an ID of the newly added service characteristic.

If the first terminal device provides a corresponding data service in the form of broadcast or groupcast, it is unnecessary for the third terminal device to feedback, and updating in the data plane can be directly performed. If the first terminal device provides the corresponding data service in the form of unicast, it is required for the first terminal device to wait for feedback from the third terminal device before initiating transmission in the data plane.

Then, the first terminal device transmits negotiated data stream to the third terminal device.

For ease of understanding, FIG. 4 shows an example of relevant information flows between a service UE (a second terminal device), a relay UE (a first terminal device), and a remote UE (a third terminal device). The relay UE may be a single relay UE or a local network formed by multiple relay UEs. In step 1, the service UE, for example, transmits its service information to the relay UE in the form of broadcast or group cast. It should be noted that although only one service UE is shown in FIG. 4, it is only representative and there may be multiple service UEs. In step 2, the relay UE includes the service information in a service availability notification, such as in the providing information described above, and then broadcasts or groupcasts the service availability notification to the remote UE. In step 3, the remote UE having a specific service requirement receives a service availability notification, and transmits a service trigger request to the relay UE in a case that the phase of the remote UE matches the phase of the relay UE. The service trigger request includes requirement information of the service characteristics of the relay UE, and may further include the phase information, the QoS requirement or the like of the relay UE. In step 4, the relay UE, in response to the service trigger request, performs preparation in the data plane, and transmits a service configuration notification, that is, confirmation information. In a case of multicast, the service configuration notification only includes a notification about the data service to be provided. In a case of unicast, the service configuration notification further includes a unicast link establishment request, and in step 5, the remote UE provides feedback to the relay UE on whether to accept the unicast link establishment request. In step 6, the relay UE transmits the required service data to the remote UE.

In addition, in step 3, the remote UE may transmit a service trigger request to multiple relay UEs, obtain service availability notifications from the multiple relay UEs, and select a most appropriate relay UE from among the multiple relay UEs for access. It should be noted that these information flows are only examples and not restrictive.

In an example, it is assumed that the first terminal device is located in a first mesh network, that is, the first terminal device is a relay UE in the first mesh network. The transmitting unit 202 is further configured to: transmit service content requirement information to one or more fourth terminal devices outside the first mesh network. The receiving unit 201 receives a networking request from a fourth terminal device in response to the service content requirement information.

The service content requirement information, for example, includes a description of a specific service type and a service characteristic or a description of a coverage requirement in a certain direction, to request peripheral terminal devices (referred to as the fourth terminal device) that have not joined the network to join the network to provide corresponding services or expand the coverage area of existing services. The service content requirement information may be transmitted together with the providing information described above in the form of multicast, or the service content requirement information may be transmitted separately, which is not limited.

If a fourth terminal device, which is not currently online, receives the service content requirement information and determines that the fourth terminal device may meet the related requirement, the fourth terminal device may transmit a networking request. The networking request may be received and processed by any relay UE in the first mesh network, not limited to the first terminal device.

For example, in a case that the fourth terminal device is to access in the first mesh network as a relay UE, the networking request may include phase information of the fourth terminal device, a coverage type provided by the fourth terminal device, and transmission power or expected transmission distances corresponding to respective coverage types, thereby notifying the first mesh network of the service range that can be provided by the fourth terminal device. In addition, in an initial networking case, that is, the fourth terminal device serves as an initial UE for network establishment due to a requirement from an application layer for example, the fourth terminal device may also transmit such a networking request to the first terminal device.

In a case that the fourth terminal device is to access in the first mesh network as a service UE, the networking request may include service information of the fourth terminal device. The networking request may further include phase information of the first terminal device. In addition, in an initial networking case, that is, the fourth terminal device serves as an initial UE for network establishment due to a requirement from an application layer for example, the fourth terminal device may also transmit such a networking request to the first terminal device.

For example, the first terminal device reviews the networking request or forwards the received networking request to a central node of the first mesh network for review. In a case that the first terminal device forwards the received networking request to the central node of the first mesh network for review, the first mesh network adopts a centralized control mechanism. Specifically, the network control logic may be deployed at a central node or multiple central nodes, where the central node may be UE, a base station, or a core network function unit. Each central node has the function of determining network configuration and determining whether to add a service UE or a relay UE. The central node further has the function of releasing updated information. If the central node is of UE type, then the UE should have authorization information from the core network.

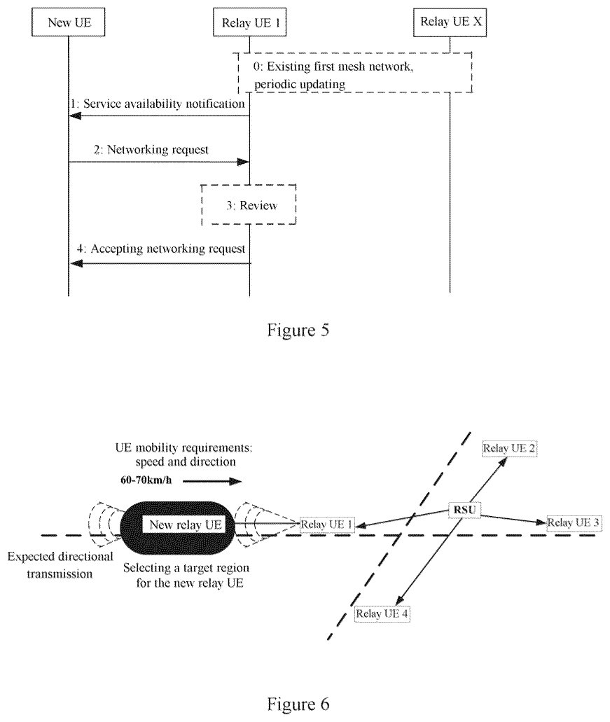

For ease of understanding, FIG. 5 shows an example of information flows of a fourth terminal device joining an existing first mesh network. In FIG. 5, relay UE 1 to relay UE X are relay nodes in the existing first mesh network. Periodic updates may be performed among relay UE 1 to relay UE X (as shown in step 0 in FIG. 5). For example, the following content may be updated: the types of services currently included in the network and service characteristics information corresponding to the respective types of services, and current node information of the network. For example, when a service UE exits the network or passively disconnects from the local network, the service UE should transmit notification information in time, or a timely update should be performed by a relay UE directly connected to the service UE. The node information of the network may include: phase information and coverage information of the nodes (such as configurations of directional transmission), service types and service characteristics information subscribed by the nodes, and the like. In a centrally controlled network, the node information may further include: the number of hops from a central node to an end node, and a number limit.

In step 1, taking the relay UE 1 as an example, the relay UE transmits a service availability notification to the external. In addition to information of data services that can be provided by the relay UE, the service availability notification further includes service content requirement information. The service content requirement information, for example, includes descriptions of specific service types and service characteristics, or descriptions of coverage requirements in a certain direction. The new UE responds after receiving the service content requirement information. The new UE may respond as a relay UE or as a service UE to transmit a networking request to the relay UE 1 (step 2). As mentioned above, the information included in the networking request may vary depending on whether the new UE serves as a relay UE or a service UE.

The relay UE 1 reviews the networking request, such as checking whether the phase matches, whether service content, coverage type and the like match requirements. In a centrally controlled network, if the relay UE 1 is not a central node, the relay UE 1 forwards the networking request to the central node for review. If the review passes, a notification of accepting the networking request is transmitted to the new UE in step 4. In this way, the new UE joins the first mesh network as a new relay UE and a new service UE, thereby expanding the coverage of the first mesh network.

FIG. 6 shows an example of phase matching for a new relay UE joining a mesh network in a scenario of internet of vehicles. In FIG. 6, a roadside unit (RSU) at an intersection transmits RSU sensing information to surrounding UEs (including vehicle UEs and VRU UEs) in the form of omnidirectional broadcast. For example, the RSU sensing information incudes sensing information or recognition information for vehicles, pedestrians, and other objects in all directions at the intersection. Based on service coverage range of its own, the RSU has requested local networking through relay UE 1 to relay UE 4 in a first layer that can communicate directly with the RSU to forward data services broadcasted by the RSU. In order to further expand the coverage range of the services of the RSU, the relay UE 1, for example, after negotiation/being indicated by RSU UE, may select, based on the information flows shown in FIG. 5, a new relay UE that matches the phase of the relay UE 1 as a new relay node. In this example, there may be differences in the forwarding processing of RSU raw service data by different relay UEs in the data plane. For example, the data forwarded by relay UE 1 may include information of four directions of the intersection, and the reason is that there may be a requirement for a relevant vehicle of immediately turning or crossing an intersection. Yet, the newly added relay UE may only include information corresponding to a section of a road in a forward direction, and the reason may be that the relevant vehicle may only need to obtain information about surrounding vehicles.

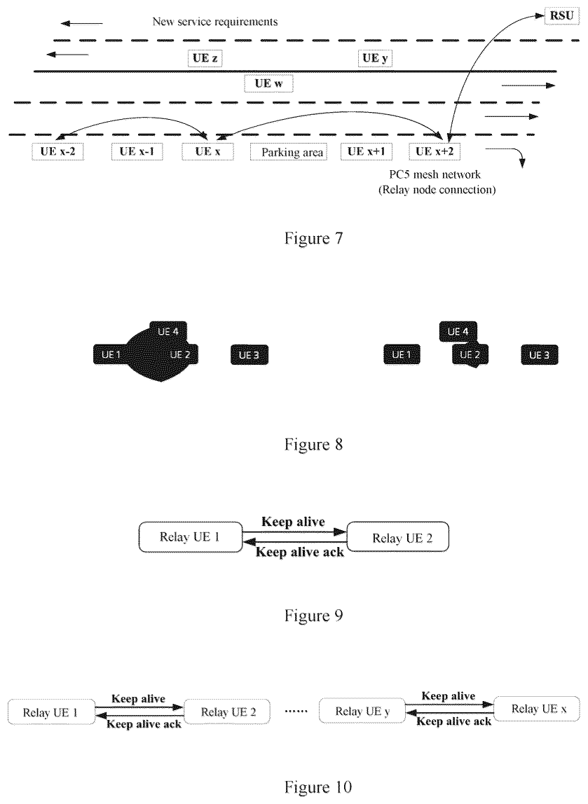

FIG. 7 shows an example of phase matching for a new service UE joining a mesh network in a scenario of internet of vehicles. In FIG. 7, UE z, UE w, and UE y travelling on the road, as remote UEs, indirectly obtain road information broadcasted by the RSU through broadcast of the two relay nodes of UE x and UE x+2. The two relay nodes may filter based on characteristics of services broadcasted by the RSU, to match the requirements of the remote UEs that the two relay nodes respectively serve. At this time, since the UE z gradually moves out of the sensing range of the RSU, the UE z has more requirements for road conditions in the forward direction. The UE x-2 stops at a position in a forward direction of UE z, and is equipped with a sensor so that the UE x-2 has the ability to provide data services. The UE x-2 may join the mesh network by executing the information flows shown in FIG. 5, thereby indirectly or directly providing data services to the UE z.

In addition, in a case that the fourth terminal device is approved to join the mesh network as a new service UE, the transmitting unit 202 is further configured to transmit network extension confirmation information to the fourth terminal device. The network extension confirmation information includes, for example, confirmation for types of services and characteristics of services that required to be transmitted by the service UE after accessing the network.

In a case that the fourth terminal device is approved to join the mesh network as a new relay UE, the transmitting unit 202 is further configured to transmit network extension confirmation information to the fourth terminal device. The network extension confirmation information includes a beam direction limitation or recommendation indication. In addition, the network extension confirmation information may further include the coverage type, such as an omnidirectional coverage or a specific directional coverage, of a previous relay UE (such as the second terminal device) of the corresponding service flow.

The beam direction limitation or recommendation indication is used to limit or recommend the transmission direction of broadcast or groupcast for the newly added relay UE, to avoid remote UEs in the same region receiving broadcast/groupcast of the same or similar service data streams from two relay UEs simultaneously. FIG. 8 shows a schematic example of beam direction limitation. In FIG. 8, UE 1 and UE 2 are relay UEs, UE 3 and UE 4 are remote UEs, and UE 2 is a newly added relay UE. In order to avoid commonly covering UE 4 with UE 1, the beam direction of UE 2 is limited to only covering the direction of UE 3.

The beam direction limitation or recommendation may be realized, for example, through beamforming. Alternatively, data streams broadcasted or groupcasted by different relay UEs may also be distinguished by different modulation and demodulation modes or different time-domains of transmitting data packets and indicating these differences in signaling.

In addition, in a case of supporting beamforming, the first terminal device may perform beam matching processing to determine the beam to be used before providing data services. The beam matching processing, for example, includes selecting a beam covering a to-be-served terminal device and avoiding covering a terminal device that has already been served by another terminal device.

If the first terminal device, before joining the mesh network as a new relay UE, is provided with network extension confirmation information including beam direction limitation or recommendation indication, the first terminal device may perform beam matching processing in a beam range based on the beam direction limitation or recommendation indication, or may perform data transmission using a beam based on the beam direction limitation or recommendation indication. The beam matching processing between UEs is to be described in detail in the fourth embodiment.

It should be noted that considering the interests of operators, it may be required to introduce the management of the local mesh network by a core network before forming and joining the PC5-based local mesh network. Usually, a completely independent PC5 port service mode (out-of-coverage) would be limited to an emergency service scenario (such as field search and rescue), and most commercial scenarios are limited to in coverage scenarios.

Specifically, there are three cases. In a first case, all UEs (including relay UEs, service UEs, and remote UEs) participating in networking are required to be online simultaneously, and permission or policy issuance for related services (local networking and localized services) is requested to related units (AMF/SMF/PCF) of the core network through a registration process (UE registration request), a UE policy update process, and the like. In a second case, any UE or a UE serving as a specific role (such as a relay UE, a service UE, or a remote UE) participating in the networking is online, and permission or policy issuance for related services (local networking and localized services) is requested to related units (AMF/SMF/PCF) of the core network through a registration process (UE registration request), a UE policy update process, and the like. In a third case, it is unnecessary for the UE to be online to initiate local networking and provide or receive services, and it is only required for the UE to obtain related service licenses in advance, such as a part of UE policies, such as factory UE configurations, USIM card configurations, and policies issued by PCF when the UE is online that have not expired, including policies that can currently be used for local networking and services.

In addition to allowing networking requests with UE policies carrying specific information elements, the management unit of the core network may also particularly issue some networking identifiers, limitations on the types of services that can be carried by short-range local networks, operable frequency bands corresponding to the short-range local networks, and geographical area/scale restrictions for networking, The networking identifier is used to uniquely identify a short-range local network in a PLMN or a specific area, such as a city or a county.

In addition, in a case that the coverage capability provided by a relay UE, such as a newly added relay UE, in a mesh network, is not the current requirement of the mesh network or a relay UE joining the network is not required to carry data transmission for any remote UE in a particular time period, the relay UE or the corresponding relay UE chain may enter a connection waiting (pending) state in that time period. In this case, the relay UE (such as the first terminal device, specifically, the transmitting unit 202 of the first terminal device) may continuously transmit keep alive signaling to mutually confirm the availability of connection wake-up.

For example, if a relay UE only at an end is in a connection pending state, it is required for the end relay UE (relay UE 1) to periodically transmit keep alive signaling to a previous-level relay node (relay UE 2) and receive keep alive ack signaling from the previous-level relay node, as shown in FIG. 9. If the relay UE 1 does not receive the keep alive ack signaling in a predetermined time period after transmitting the keep alive signaling, the relay UE 1 may determine that the relay UE 1 is not available and is disconnected from the mesh network. If the relay UE 2 does not receive the keep alive signaling from the relay UE 1 for a time period, it is determined that the relay UE 1 is not available. For example, the relay UE 1 may transmit the keep alive signaling every 10 seconds.

Alternatively, the relay UE 2 may periodically transmit keep alive signaling to the relay UE 1, and receive keep alive ack signaling from the relay UE 1. In this case, if the relay UE 2 does not receive the keep alive ack signaling in a predetermined time after transmitting the keep alive signaling, it may be determined that the relay UE 1 is not available. If the relay UE 1 does not receive the keep alive signaling from the relay UE 2 over a time period, it may be determined that the relay UE 1 is not available. For example, the relay UE 2 may transmit the keep alive signaling every 10 seconds.

In a case that a pending relay UE chain exists, a relay UE (intermediate UE 1) at an end of the chain may transmit keep alive signaling to an upper-level relay UE of the chain, and so forth, feedback is performed upwards level by level. In the feedback process at each level, an ID of a relay UE at a current level, an ID of a relay UE at a known lower level, coverage information, mobility information, and the like may be carried. In the feedback process, a top-level relay UE x which is on line and is not in a pending state is to confirm and transmit keep alive ack signaling level by level downwards, as shown in FIG. 10.

In a case that one of the relay UEs does not receive the keep alive ack signaling in a predetermined time period after transmitting keep alive signaling, it may be determined that the relay UE is not available. In a case that the top-level relay UE x which is online and is not in the pending state does not receive the keep alive signaling over a time period, it is determined that the relay UE chain is not available. In a case that feedback information is received only from some of the relay UEs, it is determined that the remaining relay UEs on the chain are not available.

In summary, the electronic apparatus 200 according to the embodiment can provide relay transmission of service data with finer granularities to better adapt to customization requirements, and enhance the coverage of multicast communication mode through scalable networking.

### Third Embodiment

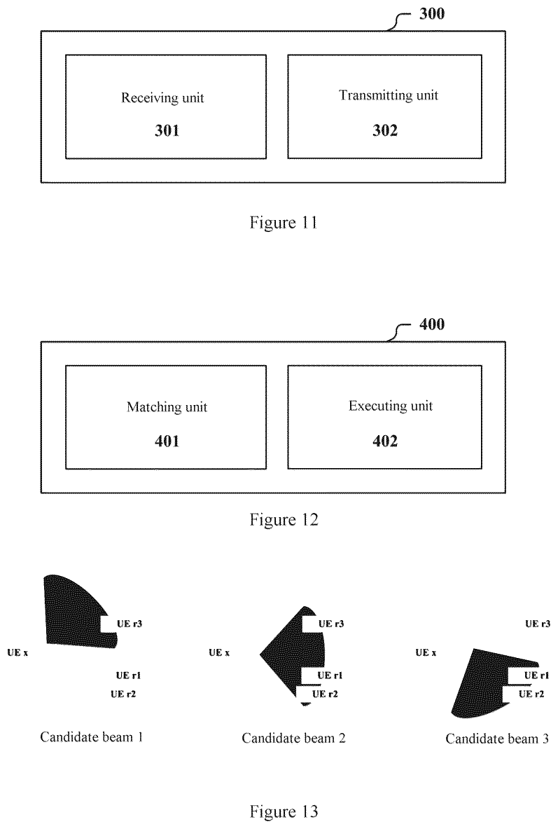

FIG. 11 shows a functional block diagram of an electronic apparatus 300 according to another embodiment of the present disclosure. As shown in FIG. 11, the electronic apparatus 300 includes a receiving unit 301 and a transmitting unit 302. The receiving unit 301 is configured to receive, from a second terminal device, providing information of data services that can be provided by the second terminal device, which is transmitted by the second terminal device via multicast. The providing information includes service information of services that can be provided, and the service information includes service type information and service characteristic information. The transmitting unit 302 is configured to transmit a service trigger request of a first terminal device to the second terminal device. The service trigger request includes requirement information of a service characteristic of the first terminal device.

The receiving unit 301 and the transmitting unit 302 may be implemented by one or more processing circuitries, and the processing circuitry, for example, may be implemented as a chip or a processor. Moreover, it should be understood that, functional units in the electronic apparatus shown in FIG. 11 are only logic modules which are divided based on the specific functions thereof, and are not intended to limit the implementations.

The electronic apparatus 300, for example, may be arranged on a first terminal device or may be communicatively connected to a first terminal device.

It should be further noted that the electronic apparatus 300 may be implemented at a chip level or a device level. For example, the electronic apparatus 300 may function as a first terminal device itself, and may include an external device such as a memory and a transceiver (not shown in FIG. 11). The memory may store programs and related data information required for implementing various functions by the electronic apparatus. The transceiver may include one or more communication interfaces to support communication with different devices (for example, other terminal devices, a base station and the like). The implementation of the transceiver is not limited herein.

The service information in this embodiment has the same meaning as the service information described in the first embodiment and the second embodiment. The descriptions in the first embodiment and the second embodiment are applicable to the third embodiment, and are not repeated herein.

In this embodiment, the first terminal device is a remote UE, and the second terminal device may be a relay UE or a service UE.

The service trigger request further includes one or more of: a QoS requirement for service data transmission, a transmission mode type requirement and phase information of the first terminal device. The phase information includes one or more of geographic location information of the first terminal device, mobility information of the first terminal device and path planning information of the first terminal device. Specific details are described in the second embodiment and are not repeated herein.

When the first terminal device has a particular service requirement, comparison may be performed based on the received providing information, and the service trigger request may be transmitted to a corresponding relay UE or service UE in a case that the requirement is met. Matching of phase information may be performed at the first terminal device or at the second terminal device. In addition, the receiving unit 301 is further configured to receive confirmation information from the second terminal device, to confirm that the second terminal device is to provide the requested data service. In a case that the transmission mode is unicast, the transmitting unit 302 is further configured to transmit a feedback to the second terminal device to indicate that establishment of a unicast link is accepted. Then, the second terminal device may provide the data service to the first terminal device.

In addition, the first terminal device may transmit a service trigger request to multiple relay UEs and/or service UEs when having a particular service requirement, obtain providing information of the multiple relay UEs and/or service information of the multiple service UEs, and select a most appropriate relay UE/or service UE therefrom for access.

Related information flows have been described in detail in the first embodiment and the second embodiment, which are applicable to this embodiment and are not repeated herein.

In addition, the first terminal device may perform beam matching processing with the second terminal device to determine a beam to be used, before performing the data transmission. The processing of beam matching between UEs is to be described in detail in the fourth embodiment.

The electronic apparatus 300 according to the embodiment can provide service data with finer granularities to better adapt to customization requirements and enhance the coverage of multicast communication mode.

### Fourth Embodiment

FIG. 12 shows a functional block diagram of an electronic apparatus 400 according to another embodiment of the present disclosure. As shown in FIG. 12, the electronic apparatus 400 includes a matching unit 401 and an executing unit 402. The matching unit 401 is configured to perform beam matching for one or more second terminal devices to select a beam to be used in communication. The executing unit 402 is configured to perform communication between a first terminal device and the one or more second terminal devices using the selected beam.

The matching unit 401 and the executing unit 402 may be implemented by one or more processing circuitry, and the processing circuitry, for example, may be implemented as a chip or a processor. Moreover, it should be understood that, functional units in the electronic apparatus shown in FIG. 12 are only logic modules which are divided based on the specific functions thereof, and are not intended to limit the implementations.

The electronic apparatus 400, for example, may be arranged on a first terminal device or may be communicatively connected to a first terminal device.

It should be further noted that the electronic apparatus 400 may be implemented at a chip level or a device level. For example, the electronic apparatus 400 may function as a first terminal device itself, and may include an external device such as a memory and a transceiver (not shown in FIG. 12). The memory may store programs and related data information required for implementing various functions by the electronic apparatus. The transceiver may include one or more communication interfaces to support communication with different devices (for example, other terminal devices, a base station and the like). The implementation of the transceiver is not limited herein.

The electronic apparatus 400 according to this embodiment may perform directional transmission of beams between UEs based on beam matching, realizing more targeted communication while avoiding interferences and improving communication efficiency.

For example, the matching unit 401 may perform beam matching by: transmitting multiple beams to the one or more second terminal devices; receiving beam quality reports generated by the one or more second terminal devices based on reception of the multiple beams; and selecting one or more beams with a best communication quality based on the beam quality reports. For example, the communication quality may be indicated by a reference signal receiving power (RSRP) or a reference signal receiving quality (RSRQ).

The first terminal device may be referred to as a transmitting UE, and the second terminal device may be referred to as a receiving UE. In the matching process, the transmitting UE may indicate indices of multiple transmitting beams. After receiving, the receiving UE feedbacks indices of one or more beams with RSRP/RSRQ higher than a predetermined threshold to the transmitting UE, and the transmitting UE selects an optimal beam from among the beams. For example, the transmitting UE may select a transmitting beam that is fed back by all the receiving UEs or a transmitting beam that is fed back by most receiving UEs. After beam matching is completed, the receiving UE may determine which receiving beam is to be used to receive data from the transmitting UE.

In a case that the first terminal device performs broadcast or groupcast with multiple second terminal devices, the matching unit 401 may, for example, firstly attempt a wide beam and then attempt a combination of a wide beam and a narrow beam or a combination of narrow beams when performing the beam matching. Of course, the matching unit 401 may only attempt narrow beams. FIG. 13 shows an example of a beam matching process. In FIG. 13, a transmitting UE x is to perform broadcast or groupcast on receiving UE r1 to UE r3. Due to a large difference in azimuths of UE r1 to UE r3, a wide beam may be used for covering the receiving UE r1 to UE r3. As shown in FIG. 13, candidate beams 1 to 3 are transmitted respecively. A receiving UE in the coverage range of a candidate beam would feedback an index of the candidate beam. For example, the UE x may select the candidate beam 2 that can cover UE r1 to UE r3.

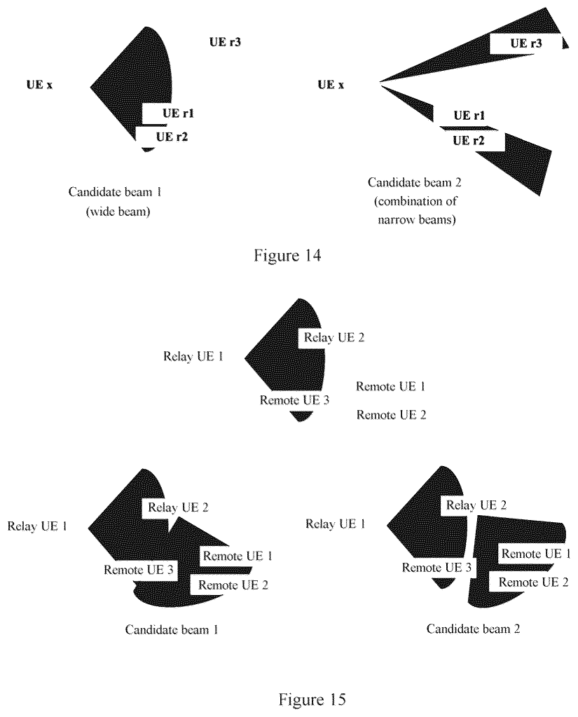

FIG. 14 shows another example of a beam matching process. In FIG. 14, none of the wide beams can fully cover UE r1 to UE r3. The transmitting UE x attempts to adopt a combination of narrow beams to cover the receiving UEs. For example, a combination of two narrow beams as shown in FIG. 14 may be adopted for broadcast or groupcast. In addition, a combination of a wide beam and a narrow beam may be adopted for broadcast or groupcast according to situations.

In addition, the matching unit 401 is further configured to avoid interferences with existing communications in selecting the beam. For example, in a case that the first terminal device is a relay terminal device (relay UE), the matching unit 401 is configured to select a beam with a communication quality lower than a predetermined threshold for a terminal device served by another terminal device. That is, in selecting a beam, the matching unit 401 needs to select a transmission beam that has a communication quality higher than a predetermined threshold for the remote UE to be served by the first terminal device and a communication quality lower than the predetermined threshold for the remote UE served by another relay UE or service UE.

For example, the other relay UE or service UE may instruct the receiving UE served by the other relay UE or service UE to perform beam evasion matching. Specifically, for example, when the receiving UE receives a beam from the first terminal device with an RSRP/RSRQ higher than a predetermined threshold, the receiving UE transmits an indication of interference occurring to the other relay UE or service UE or directly to the first terminal device, so that the first terminal device may avoid the corresponding beam in selecting beam.

It should be understood that in the above situation, the first terminal device which is as a relay UE needs to select multiple remote UEs (Group 1) to serve, and a base station or other relay UEs or service UEs indicate remote UEs (Group 2) requiring avoiding duplicate coverage to the first terminal device, and beam quality reports such as beam index feedback are performed by the remote UEs.

FIG. 15 shows an example of a beam matching process in this situation. In FIG. 15, a relay UE 1 is an existing UE in the mesh network and is serving a remote UE 3. It should be noted that although a relay UE is shown in FIG. 15, the UE may be a service UE. A relay UE 2 is a later added relay UE. The relay UE 2 performs a beam selection process before performing broadcast or groupcast, and in this process, it is required to consider affect on the UE 3 that the relay UE 1 is already serving.

The upper figure in FIG. 15 shows that a relay UE 2 and a remote UE 3 are both in a coverage range of a relay UE 1, and the relay UE 2 needs to select a suitable beam to cover a remote UE 1 and a remote UE 2 while avoiding covering the remote UE 3. The lower left figure in FIG. 15 shows a situation where a relay UE 2 transmits a candidate beam 1. The candidate beam 1 may simultaneously cover a remote UE 1 to a remote UE 3, and thus the remote UE3 is in the coverage range of the relay UE 1 and in the coverage range of the relay UE 2 simultaneously, resulting in duplicate reception or interferences from the relay UE 2 on existing data transmission. The lower right figure in FIG. 15 shows a situation where a relay UE 2 transmits a candidate beam 2. The candidate beam 2 meets the requirement, and may cover both a remote UE 1 and a remote UE 2 but not UE 3 simultaneously.

In addition, as described in the second embodiment, in the case that the first terminal device is newly added to the mesh network as a service UE or as a relay UE, the network extension confirmation information may be received from an existing relay UE. The network extension confirmation information may include the beam direction limitation or recommendation indication. Therefore, the first terminal device may perform beam matching processing based on the beam direction limitation or recommendation indication, or perform data transmission using the beam indicated by the beam direction limitation or recommendation indication.

After performing the beam matching, the executing unit 402 performs communication between the first terminal device and one or more second terminal devices using the selected beam, which may be in the unicast mode, or in the broadcast mode, or in the groupcast mode. That is, the executing unit 402 performs data transmission based on beamforming.

The electronic apparatus 400 according to this embodiment can achieve directional data transmission by performing beam matching, improving communication efficiency.

### Fifth Embodiment

In the above description of embodiments of the electronic apparatuses for wireless communications, it is apparent that some processing and methods are further disclosed. In the following, a summary of the methods are described without repeating details that are described above. However, it should be noted that although the methods are disclosed when describing the electronic apparatuses for wireless communications, the methods are unnecessary to adopt those components or to be performed by those components described above. For example, implementations of the electronic apparatuses for wireless communications may be partially or completely implemented by hardware and/or firmware. Methods for wireless communications to be discussed blow may be completely implemented by computer executable programs, although these methods may be implemented by the hardware and/or firmware for implementing the electronic apparatuses for wireless communications.

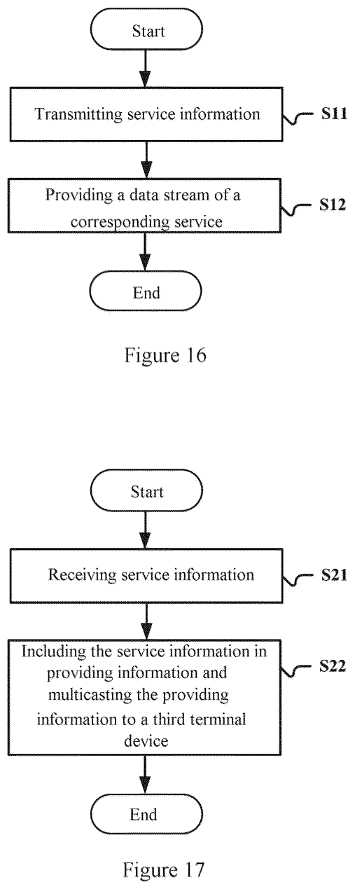

FIG. 16 shows a flowchart of a method for wireless communications according to an embodiment of the present disclosure. The method includes: transmitting service information of services that can be provided by a first terminal device to one or more second terminal devices (S11), where the service information includes service type information and service characteristic information; and providing, based on the service information, a data stream of a corresponding service to at least one terminal device among the one or more second terminal devices (S12). The method, for example, may be performed at the first terminal device side.

For example, in step S11, the service information may be transmitted in at least one transmission mode of broadcast, groupcast, and unicast through a PC5 port.

For example, the service type information indicates a type of a service provided by the first terminal device, and the service characteristic information indicates indicating information of a characteristic of a service of one or more granularities under the type of the service. The type of service may include: perception of a specific region, provision of target information in the specific region, a map information service, a task information release service, and parameter updating in deploying or training an artificial intelligence/machine learning model. The service characteristic information, for example, includes one or more of: a service characteristic identification, service characteristic differentiation information, a directional or regional transmission requirement, and relay transmission related information. The service characteristic differentiation information may include one or more of: a geographic range involved in service data, service source information/sensor information, and a map resolution. The directional or regional transmission requirement includes a transmission requirement for a specific direction or a transmission requirement for a specific region. The relay transmission related information includes one or more of: a transmission range of service data, whether relay transmission is capable of being performed, a directional or regional transmission requirement of the relay transmission, and a hop limit of the relay transmission.

The service information may further include a transmission mode of a data stream carrying the services.

The step S12 further includes: marking a data packet in the data stream of the corresponding service based on the service characteristic information, and then transmitting the data packet. For example, the data packet may be marked by one of: marking a specific field in a header of the data packet in a specific transport protocol layer included in a transport protocol stack; or modulating data in the data packet in a modulation mode corresponding to the service characteristic information and then transmitting the data packet; or transmitting the data packet in a time period corresponding to the service characteristic information.

The step S11 further includes: providing phase information of the first terminal device to the second terminal devices. The phase information includes one or more of geographic location information of the first terminal device, mobility information of the first terminal device and path planning information of the first terminal device.

For example, the second terminal device may be a relay device and configured to transmit the data stream to one or more third terminal devices. Although not shown in FIG. 16, the method may further include: transmitting, in response to service content requirement information from a second terminal device, a networking request to the second terminal device. The networking request includes the service information and the phase information of the first terminal device.

The above method corresponds to the electronic apparatus 100 described in the first embodiment, and detailed descriptions may refer to the first embodiment and are not repeated herein.

FIG. 17 shows a flowchart of a method for wireless communications according to another embodiment of the present disclosure. The method includes: receiving, from a second terminal device, service information of services that can be provided by the second terminal device (S21), where the service information includes service type information and service characteristic information; and including the service information in providing information of data services that can be provided by a first terminal device and multicasting the providing information to one or more third terminal devices (S22). The method, for example, may be performed at the first terminal device side.

For example, in the step S21, the service information may be received in at least one transmission mode of broadcast, groupcast, or unicast through a PC5 port. The meaning of service information has been described in detail above and is applicable in the method in this embodiment, and is not repeated herein.

For example, in a case that the relay transmission related information indicates that the relay transmission can be performed, the service information is included in the providing information and the providing information is multicast to the one or more third terminal devices in step S22. The service information may further include phase information of the first terminal device.

Although not shown in FIG. 17, the above method may further include: receiving, from a third terminal device, a service trigger request, where the service trigger request includes requirement information of a service characteristic of the third terminal device; matching the service trigger request with the data services that can be provided by the first terminal device; and providing, in a case that the requirement information matches the data services that can be provided by the first terminal device, a data service to the third terminal device. Providing a data service to the third terminal device may include one of: adding the third terminal device to a subscription group for a data service with exactly matched content which is being provided by the first terminal device; newly adding a data service that meets a requirement of the third terminal device, and adding the third terminal device to a subscription group for the newly added data service; or establishing a unicast data service of the first terminal device for the third terminal device.

The service trigger request may further include one or more of: a QoS requirement for service data transmission, a transmission mode type requirement and phase information of the third terminal device.

In an example, the first terminal device is located in a first mesh network, and the method further includes: transmitting service content requirement information to one or more fourth terminal devices outside the first mesh network, and receiving a networking request transmitted by a fourth terminal device in response to the service content requirement information. For example, the networking request includes phase information of the fourth terminal device, a coverage type provided by the fourth terminal device, and transmission power or expected transmission distances corresponding to respective coverage types; or the networking request includes service information of the fourth terminal device. The method further includes: reviewing the networking request or forwarding the networking request to a central node of the first mesh network for review.

The method further includes: transmitting network extension confirmation information to the fourth terminal device. The network extension confirmation information includes a beam direction limitation or recommendation indication.

In addition, beam matching processing may be performed to determine a beam to be used before providing the data services. For example, the beam matching processing includes selecting a beam covering a to-be-served terminal device and avoiding covering a terminal device that has already been served by another terminal device.

The above method corresponds to the electronic apparatus 200 described in the second embodiment, and detailed descriptions may refer to the second embodiment and are not repeated herein.

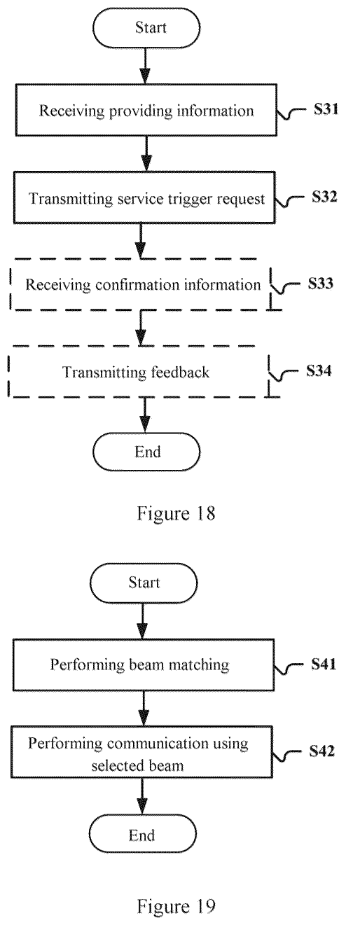

FIG. 18 shows a flowchart of a method for wireless communications according to another embodiment of the present disclosure. The method includes: receiving, from a second terminal device, providing information of data services that can be provided by the second terminal device, which is transmitted by the second terminal device via multicast (S31), where the providing information includes service information of services that can be provided, and the service information includes service type information and service characteristic information; and transmitting a service trigger request of a first terminal device to the second terminal device (S32), where the service trigger request includes requirement information of a service characteristic of the first terminal device. The method, for example, may be performed at the first terminal device side.

The meaning of service information has been described in detail above and is applicable in the method in this embodiment, and is not repeated herein.

For example, the service trigger request may further include one or more of: a QoS requirement for service data transmission, a transmission mode type requirement and phase information of the first terminal device.

As shown in the dashed line block in FIG. 18, the method may further include a step S33: receiving confirmation information from the second terminal device. In addition, in a case of unicast transmission mode, the method further includes a step S34: transmitting a feedback to the second terminal device.

In addition, although not shown in FIG. 18, the method may further include: performing beam matching processing with the second terminal device before data transmission to determine a beam to be used.

The above method corresponds to the electronic apparatus 300 described in the third embodiment, and detailed descriptions may refer to the third embodiment and are not repeated herein.

FIG. 19 shows a flowchart of a method for wireless communications according to another embodiment of the present disclosure. The method includes: performing beam matching for one or more second terminal devices to select a beam to be used in communication (S41); and performing communication between a first terminal device and the one or more second terminal devices using the selected beam (S42). The method, for example, may be performed at the first terminal device side.

For example, in step S41, the beam matching may be performed by: transmitting multiple beams to the one or more second terminal devices; receiving beam quality reports generated by the one or more second terminal devices based on reception of the multiple beams; and selecting one or more beams with the best communication quality based on the beam quality reports. The communication quality may be indicated by a reference signal receiving power or a reference signal receiving quality.

In performing the beam matching, a wide beam may be firstly attempted, and then a combination of a wide beam and a narrow beam or a combination of narrow beams may be attempted. In selecting the beam, interferences with existing communications may be avoided.

For example, the first terminal device is a relay terminal device. In step S41, a beam with a communication quality lower than a predetermined threshold for a terminal device served by another terminal device is selected.

The above method corresponds to the electronic apparatus 400 described in the fourth embodiment, and detailed descriptions may refer to the fourth embodiment and are not repeated herein.

It should be noted that the above methods may be performed in combination or separately

The electronic apparatus 100 to the electronic apparatus 400 may be implemented as various terminal devices or user equipment. Each of the terminal devices or the user equipment may include one or more of the electronic apparatus 100 to 400, or perform some or all of the functions of the electronic apparatus 100 to 400.

The terminal device or the user equipment may be implemented as a mobile terminal (such as a smart phone, a tablet personal computer (PC), a notebook PC, a portable game terminal, a portable/dongle type mobile router, and a digital camera device), or an in-vehicle terminal (such as a car navigation device). The terminal device or the user equipment may also be implemented as a terminal (which is also referred to as a machine type communication (MTC) terminal) that performs machine-to-machine (M2M) communication. Furthermore, the terminal device or the user equipment may be a wireless communication module (such as an integrated circuit module including a single chip) mounted on each of the terminals.

### [Application Examples Regarding a Terminal Device]

### (First Application Example)

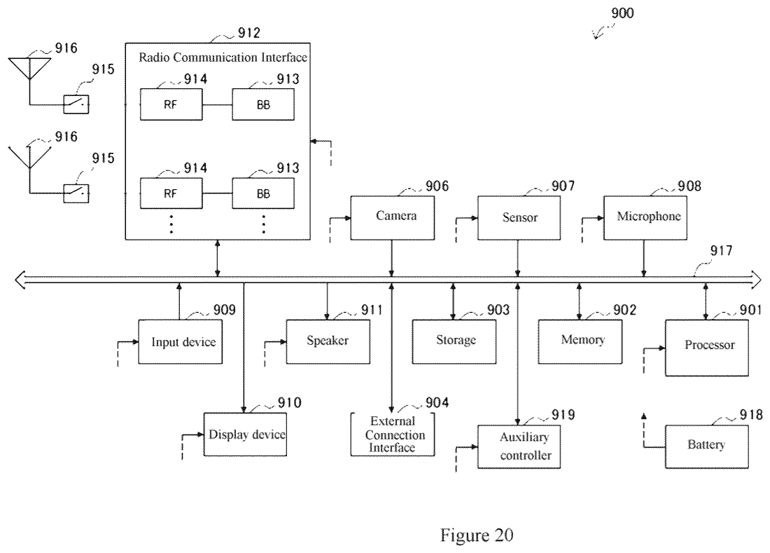

FIG. 20 is a block diagram showing an example of a schematic configuration of a smartphone 900 to which the technology according to the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and another layer of the smartphone 900. The memory 902 includes a RAM and a ROM, and stores programs executed by the processor 901 and data. The storage 903 may include a storage medium, such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)) and generates a captured image. The sensor 907 may include a set of sensors, such as a measurement sensor, a gyroscope sensor, a geomagnetic sensor and an acceleration sensor. The microphone 908 converts sound inputted into the smart phone 900 into an audio signal. The input device 909 includes, for example, a touch sensor configured to detect touch onto a screen of the display device 910, a keypad, a keyboard, a button, or a switch, and receives an operation or information inputted from a user. The display device 910 includes a screen (such as a liquid crystal display (LCD) and an organic light-emitting diode (OLED) display), and displays an output image of the smartphone 900. The loudspeaker 911 converts the audio signal outputted from the smart phone 900 into sound.

The radio communication interface 912 supports any cellular communication scheme (such as LTE and LTE-advanced), and performs wireless communication. The radio communication interface 912 may generally include, for example, a BB processor 913 and an RF circuit 914. The BB processor 913 may perform, for example, encoding/decoding, modulating/demodulating, and multiplexing/de-multiplexing, and perform various types of signal processing for wireless communication. In addition, the RF circuit 914 may include, for example, a frequency mixer, a filter, and an amplifier, and transmits and receives wireless signals via an antenna 916. The radio communication interface 912 may be a one chip module having the BB processor 913 and the RF circuit 914 integrated thereon. As illustrated in FIG. 20, the radio communication interface 912 may include the multiple BB processors 913 and the multiple RF circuits 914. Although FIG. 20 shows the example in which the radio communication interface 912 includes the multiple BB processors 913 and the multiple RF circuits 914, the radio communication interface 912 may also include a single BB processor 913 or a single RF circuit 914.

Furthermore, in addition to a cellular communication scheme, the radio communication interface 912 may support another type of wireless communication scheme, such as a short-distance wireless communication scheme, a near field communication scheme, and a wireless local area network (LAN) scheme. In this case, the radio communication interface 912 may include the BB processor 913 and the RF circuit 914 for each of the wireless communication schemes.

Each of the antenna switches 915 switches connection destinations of the antennas 916 among multiple circuits (such as circuits for different wireless communication schemes) included in the radio communication interface 912.

Each of the antennas 916 includes a single or multiple antenna elements (such as multiple antenna elements included in an MIMO antenna), and is used for the radio communication interface 912 to transmit and receive wireless signals. As shown in FIG. 20, the smartphone 900 may include the multiple antennas 916. Although FIG. 20 shows the example in which the smartphone 900 includes the multiple antennas 916, the smartphone 900 may also include a single antenna 916.

Furthermore, the smartphone 900 may include the antenna 916 for each wireless communication scheme. In this case, the antenna switch 915 may be omitted from the configuration of the smart phone 900.

The bus 917 connects the processor 901, the memory 902, the storage 903, the external connection interface 904, the camera 906, the sensor 907, the microphone 908, the input device 909, the display device 910, the loudspeaker 911, the radio communication interface 912 and the auxiliary controller 919 with each other. The battery 918 supplies power for blocks in the smart phone 900 shown in FIG. 20 via a feeder which is indicated partially as a dashed line in FIG. 20. The auxiliary controller 919, for example, controls a minimum necessary function for operating the smart phone 900 in a sleeping mode.

In the smart phone 900 shown in FIG. 20, the transceiving unit 101, the providing unit 102 and the transceiver of the electronic apparatus 100, the receiving unit 201, the transmitting unit 202 and the transceiver of the electronic apparatus 200, the receiving unit 301, the transmitting unit 302 and the transceiver of the electronic apparatus 300, or the transceiver of the electronic apparatus may be implemented by the radio communication interface 912. At least part of the functions may also be implemented by the processor 901 or the auxiliary controller 919. For example, the processor 901 or the auxiliary controller 919 may perform the functions of the transceiving unit 101 and the providing unit 102 to provide service data with finer granularities and enhance the coverage of the mesh network, may perform the functions of the receiving unit 201 and the transmitting unit 202 to perform relay transmission of service data with finer granularities and enhance coverage in multicast communication mode, may perform the functions of the receiving unit 301 and the transmitting unit 302 to obtain service data with finer granularities and enhance coverage in multicast communication mode, and may perform the functions of the matching unit 401 and the executing unit 402 to perform beam matching processing between terminal devices and data transmission based on beamforming.

### (Second Application Example)

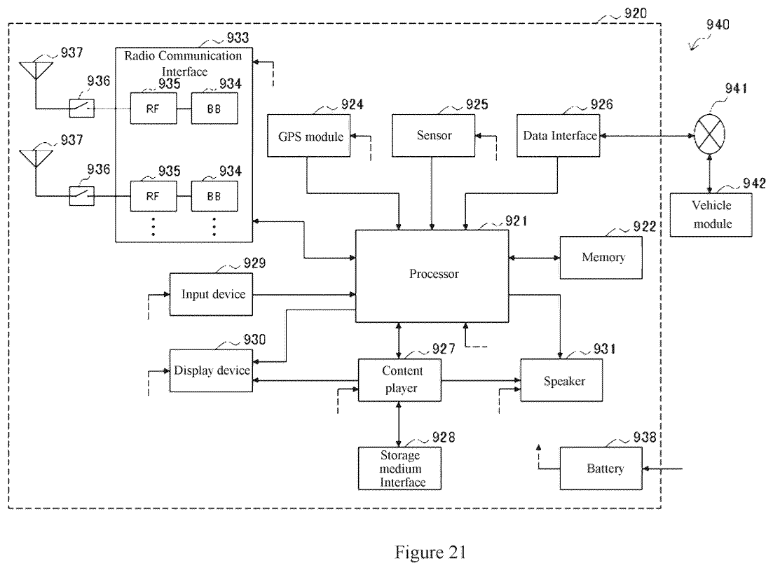

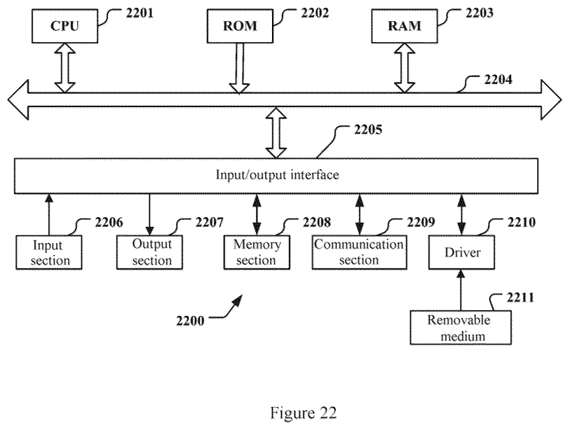

FIG. 21 is a block diagram showing an example of a schematic configuration of a car navigation device 920 to which the technology according to the present disclosure may be applied. The car navigation device 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or a SoC, and controls the navigation function and additional functions of the car navigation device 920. The memory 922 includes a RAM and a ROM, and stores programs executed by the processor 921 and data.

The GPS module 924 measures a position (such as a latitude, a longitude, and a height) of the car navigation device 920 based on a GPS signal received from a GPS satellite. The sensor 925 may include a group of sensors, such as, a gyroscope sensor, a geomagnetic sensor, and an air pressure sensor. The data interface 926 is connected to, for example, an in-vehicle network 941 via a terminal which is not shown, and acquires data generated by the vehicle (such as vehicle speed data).

The content player 927 reproduces contents stored in a storage medium (such as a CD and a DVD), where the storage medium is inserted into the storage medium interface 928. The input device 929 includes, for example, a touch sensor configured to detect touch on a screen of the display device 930, a button, or a switch, and receives an operation or information inputted from a user. The display device 930 includes a screen, for example, an LCD display or an OLED display, and displays an image with a navigation function or the reproduced content. The loudspeaker 931 outputs a sound with a navigation function or the reproduced content.

The radio communication interface 933 supports any cellular communication scheme (such as, LTE and LTE-Advanced), and performs wireless communication. The radio communication interface 933 may usually include, for example, a BB processor 934 and an RF circuit 935. The BB processor 934 may perform, for example, encoding/decoding, modulating/demodulating, and multiplexing/de-multiplexing, and performs various types of signal processing for wireless communication. In addition, the RF circuit 935 may include, for example, a frequency mixer, a filter, and an amplifier, and transmit and receive wireless signals via the antenna 937. The radio communication interface 933 may also be a chip module on which the BB processor 934 and the RF circuit 935 are integrated. As shown in FIG. 21, the radio communication interface 933 may include multiple BB processors 934 and multiple RF circuits 935. Although FIG. 21 shows an example in which the radio communication interface 933 includes multiple BB processors 934 and multiple RF circuits 935, the radio communication interface 933 may include a single BB processor 934 or a single RF circuit 935.

Furthermore, in addition to a cellular communication scheme, the radio communication interface 933 may support another type of wireless communication scheme, such as a short-distance wireless communication scheme, a near field communication scheme, and a wireless LAN scheme. In this case, for each of the wireless communication schemes, the radio communication interface 933 may include a BB processor 934 and an RF circuit 935.

Each of the antenna switches 936 switches connection destinations of the antennas 937 among multiple circuits (such as circuits for different wireless communication schemes) included in the radio communication interface 933.

Each of the antennas 937 includes one or more antenna elements (such as multiple antenna elements included in a MIMO antenna) and is used by the radio communication interface 933 to transmit and receive wireless signals. As shown in FIG. 21, the car navigation device 920 may include multiple antennas 937. Although FIG. 21 shows the example in which the car navigation device 920 includes the multiple antennas 937, the car navigation device 920 may also include a single antenna 937.

Furthermore, the car navigation device 920 may include an antenna 937 for each of the wireless communication schemes. In this case, the antenna switch 936 may be omitted from the configuration of the car navigation device 920.

The battery 938 supplies power to each of the blocks of the car navigation device 920 shown in FIG. 21 via feeders which are partially shown with dashed lines in FIG. 21. The battery 938 accumulates power supplied from the vehicle.

In the car navigation device 920 shown in FIG. 21, the transceiving unit 101, the providing unit 102 and the transceiver of the electronic apparatus 100, the receiving unit 201, the transmitting unit 202 and the transceiver of the electronic apparatus 200, the receiving unit 301, the transmitting unit 302 and the transceiver of the electronic apparatus 300, or the transceiver of the electronic apparatus may be implemented by the radio communication interface 933. At least part of the functions may also be implemented by the processor 921. For example, the processor 921 may perform the functions of the transceiving unit 101 and the providing unit 102 to provide service data with finer granularities and enhance the coverage of the mesh network, may perform the functions of the receiving unit 201 and the transmitting unit 202 to perform relay transmission of service data with finer granularities and enhance coverage in multicast communication mode, may perform the functions of the receiving unit 301 and the transmitting unit 302 to obtain service data with finer granularities and enhance coverage in multicast communication mode, and may perform the functions of the matching unit 401 and the executing unit 402 to perform beam matching processing between terminal devices and data transmission based on beamforming.

The technology according to the present disclosure may also be implemented as an in-vehicle system (or a vehicle) 940 including one or more blocks of the car navigation device 920, the in-vehicle network 941 and a vehicle module 942. The vehicle module 942 generates vehicle data (such as vehicle speed, engine speed, and fault information), and outputs the generated data to the in-vehicle network 941.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

In the case where the present disclosure is realized with software or firmware, a program constituting the software is installed in a computer with a dedicated hardware structure (e.g. the general computer 2200 shown in FIG. 22) from a storage medium or network, wherein the computer is capable of implementing various functions when installed with various programs.

In FIG. 22, a central processing unit (CPU) 2201 executes various processing according to a program stored in a read-only memory (ROM) 2202 or a program loaded to a random access memory (RAM) 2203 from a memory section 2208. The data needed for the various processing of the CPU 2201 may be stored in the RAM 2203 as needed. The CPU 2201, the ROM 2202 and the RAM 2203 are linked with each other via a bus 2204. An input/output interface 2205 is also linked to the bus 2204.

The following components are linked to the input/output interface 2205: an input section 2206 (including keyboard, mouse and the like), an output section 2207 (including displays such as a cathode ray tube (CRT), a liquid crystal display (LCD), a loudspeaker and the like), a memory section 2208 (including hard disc and the like), and a communication section 2209 (including a network interface card such as a LAN card, modem and the like). The communication section 2209 performs communication processing via a network such as the Internet. A driver 2210 may also be linked to the input/output interface 2205, if needed. If needed, a removable medium 2211, for example, a magnetic disc, an optical disc, a magnetic optical disc, a semiconductor memory and the like, may be installed in the driver 2210, so that the computer program read therefrom is installed in the memory section 2208 as appropriate.

In the case where the foregoing series of processing is achieved through software, programs forming the software are installed from a network such as the Internet or a memory medium such as the removable medium 2211.

It should be appreciated by those skilled in the art that the memory medium is not limited to the removable medium 2211 shown in FIG. 22, which has program stored therein and is distributed separately from the apparatus so as to provide the programs to users. The removable medium 2211 may be, for example, a magnetic disc (including floppy disc (registered trademark)), a compact disc (including compact disc read-only memory (CD-ROM) and digital versatile disc (DVD), a magneto optical disc (including mini disc (MD) (registered trademark)), and a semiconductor memory. Alternatively, the memory medium may be the hard discs included in ROM 2202 and the memory section 2208 in which programs are stored, and can be distributed to users along with the device in which they are incorporated.

To be further noted, in the apparatus, method and system according to the present disclosure, the respective components or steps can be decomposed and/or recombined. These decompositions and/or re-combinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a (n)” in which an element is defined will not preclude presence of an additional identical element(s) in a process, method, article or device comprising the defined element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for wireless communications, comprising:
at least one processor; and
at least one memory including computer program code, where the at least one memory and the computer program code are configured, with the at least one processor, to cause the electronic apparatus to:
transmit service information of services that can be provided by a first terminal device to one or more second terminal devices, wherein the service information comprises service type information and service characteristic information; and
provide, based on the service information, a data stream of a corresponding service to at least one terminal device among the one or more second terminal devices.

2. The electronic apparatus according to claim 1, wherein the at least one memory and the computer program code are configured, with the at least one processor, to cause the electronic apparatus to:
transmit the service information in at least one transmission mode of broadcast, groupcast, and unicast through a PC5 port.

3. The electronic apparatus according to claim 1, wherein the service type information indicates a type of a service provided by the first terminal device, and the service characteristic information indicates indicating information of a characteristic of a service of one or more granularities under the type of the service, and/or
wherein the type of service comprises: perception of a specific region, provision of target information in the specific region, a map information service, a task information release service, and parameter updating in deploying or training an artificial intelligence/machine learning model, and/or
wherein the service characteristic information comprises one or more of: a service characteristic identification, service characteristic differentiation information, a directional or regional transmission requirement, and relay transmission related information.

4-5. (canceled)

6. The electronic apparatus according to claim 3, wherein the service characteristic differentiation information comprises one or more of: a geographic range involved in service data, service source information/sensor information, and a map resolution, and/or
wherein the directional or regional transmission requirement comprises a transmission requirement for a specific direction or a transmission requirement for a specific region, and the relay transmission related information comprises one or more of: a transmission range of service data, whether relay transmission can be performed, a directional or regional transmission requirement of the relay transmission, and a hop limit of the relay transmission.

7. (canceled)

8. The electronic apparatus according to claim 1, wherein the service information further comprises a transmission mode of a data stream carrying the services.

9. The electronic apparatus according to claim 1, wherein the at least one memory and the computer program code are further configured, with the at least one processor, to cause the electronic apparatus to mark a data packet in the data stream of the corresponding service based on the service characteristic information, and then transmit the data packet, and/or
wherein the at least one memory and the computer program code are further configured, with the at least one processor, to cause the electronic apparatus to mark the data packet by one of:
marking a specific field in a header of the data packet in a specific transport protocol layer comprised in a transport protocol stack;
modulating data in the data packet in a modulation mode corresponding to the service characteristic information and then transmitting the data packet; and
transmitting the data packet in a time period corresponding to the service characteristic information.

10. (canceled)

11. The electronic apparatus according to claim 1, wherein the at least one memory and the computer program code are further configured, with the at least one processor, to cause the electronic apparatus to provide phase information of the first terminal device to the second terminal devices, wherein the phase information comprises one or more of geographic location information of the first terminal device, mobility information of the first terminal device and path planning information of the first terminal device.

12. The electronic apparatus according to claim 1, wherein the second terminal device is a relay device, and is configured to transmit the data stream to one or more third terminal devices, and
wherein the at least one memory and the computer program code are further configured, with the at least one processor, to cause the electronic apparatus to transmit, in response to service content requirement information from the second terminal device, a networking request to the second terminal device, wherein the networking request comprises the service information and the phase information of the first terminal device.

13. (canceled)

14. An electronic apparatus for wireless communications, comprising:
at least one processor; and
at least one memory including computer program code, where the at least one memory and the computer program code are configured, with the at least one processor, to cause the electronic apparatus to:
receive, from a second terminal device, service information of services that can be provided by the second terminal device, wherein the service information comprises service type information and service characteristic information; and
comprise the service information in providing information of data services that can be provided by a first terminal device and multicast the providing information to one or more third terminal devices.

15. The electronic apparatus according to claim 14, wherein the at least one memory and the computer program code are configured, with the at least one processor, to cause the electronic apparatus to receive the service information in at least one transmission mode of broadcast, groupcast, or unicast through a PC5 port.

16. The electronic apparatus according to claim 14, wherein the service type information indicates a type of a service provided by the second terminal device, and the service characteristic information indicates indicating information of a characteristic of a service of one or more granularities under the type of the service, and/or
wherein the type of service comprises: perception of a specific region, provision of target information in the specific region, a map information service, a task information release service, and parameter updating in deploying or training an artificial intelligence/machine learning model, and/or
wherein the service characteristic information comprises one or more of: a service characteristic identification, service characteristic differentiation information, a directional or regional transmission requirement, relay transmission related information, and a service reliability requirement, and/or
wherein the service characteristic differentiation information comprises one or more of: a geographic range involved in service data, service source information/sensor information, and a map resolution, and/or
wherein the directional or regional transmission requirement comprises a transmission requirement for a specific direction or a transmission requirement for a specific region, and the relay transmission related information comprises one or more of: a transmission range of service data, whether relay transmission can be performed, a directional or regional transmission requirement of the relay transmission, a hop limit of the relay transmission, and the service reliability requirement.

17.-20. (canceled)

21. The electronic apparatus according to claim 16, wherein the at least one memory and the computer program code are configured, with the at least one processor, to cause the electronic apparatus to comprise, in a case that the relay transmission related information indicates that the relay transmission can be performed, the service information in the providing information, and multicast the providing information to the one or more third terminal devices.

22. The electronic apparatus according to claim 14, wherein the service information further comprises a transmission mode of a data stream carrying the services, and/or
wherein the providing information further comprises phase information of the first terminal device, and the phase information comprises one or more of geographic location information of the first terminal device, mobility information of the first terminal device and path planning information of the first terminal device.

23. (canceled)

24. The electronic apparatus according to claim 14, wherein the at least one memory and the computer program code are further configured, with the at least one processor, to cause the electronic apparatus to:
receive, from a third terminal device, a service trigger request, wherein the service trigger request comprises requirement information of a service characteristic of the third terminal device;
match the service trigger request with the data services that can be provided by the first terminal device; and
provide, in a case that the requirement information matches the data services that can be provided by the first terminal device, a data service to the third terminal device.

25. The electronic apparatus according to claim 24, wherein providing the data service to the third terminal device comprises one of:
adding the third terminal device to a subscription group for a data service with exactly matched content which is being provided by the first terminal device;
newly adding a data service that meet a requirement of the third terminal device, and adding the third terminal device to a subscription group for the newly added data service; and
establishing a unicast data service of the first terminal device for the third terminal device, and/or
wherein the service trigger request further comprises one or more of: a QoS requirement for service data transmission, a transmission mode type requirement and phase information of the third terminal device, and the phase information comprises one or more of geographic location information of the third terminal device, mobility information of the third terminal device and path planning information of the third terminal device.

26. (canceled)

27. The electronic apparatus according to claim 14, wherein the first terminal device is located in a first mesh network, and the at least one memory and the computer program code are further configured, with the at least one processor, to cause the electronic apparatus to: transmit service content requirement information to one or more fourth terminal devices outside the first mesh network, and receive a networking request from a fourth terminal device in response to the service content requirement information,
wherein the networking request comprises phase information of the fourth terminal device, a coverage type provided by the fourth terminal device, and transmission power or expected transmission distances corresponding to respective coverage types; alternatively, the networking request comprises service information of the fourth terminal device; and
the at least one memory and the computer program code are configured, with the at least one processor, to cause the electronic apparatus to review the networking request, or forward the networking request to a central node of the first mesh network for review, and
wherein the at least one memory and the computer program code are further configured, with the at least one processor, to cause the electronic apparatus to transmit network extension confirmation information to the fourth terminal device, and the network extension confirmation information comprises a beam direction limitation or recommendation indication.

28-29. (canceled)

30. The electronic apparatus according to claim 24, wherein the at least one memory and the computer program code are further configured, with the at least one processor, to cause the electronic apparatus to perform beam matching processing to determine a beam to be used before providing the data services,
wherein the beam matching processing comprises selecting a beam covering a to-be-served terminal device and avoiding covering a terminal device that has already been served by another terminal device.

31. (canceled)

32. An electronic apparatus for wireless communications, comprising:
at least one processor; and
at least one memory including computer program code, where the at least one memory and the computer program code are configured, with the at least one processor, to cause the electronic apparatus to:
receive, from a second terminal device, providing information of data services that can be provided by the second terminal device, which is transmitted by the second terminal device via multicast, wherein the providing information comprises service information of services that can be provided, and the service information comprises service type information and service characteristic information; and
transmit a service trigger request of a first terminal device to the second terminal device, wherein the service trigger request comprises requirement information of a service characteristic of the first terminal device.

33. The electronic apparatus according to claim 32, wherein the service trigger request further comprises one or more of: a QoS requirement for service data transmission, a transmission mode type requirement and phase information of the first terminal device, and the phase information comprises one or more of geographic location information of the first terminal device, mobility information of the first terminal device and path planning information of the first terminal device.

34. The electronic apparatus according to claim 32, wherein the at least one memory and the computer program code are further configured, with the at least one processor, to cause the electronic apparatus to:
receive confirmation information from the second terminal device, and transmit a feedback to the second terminal device in a case of a transmission mode being unicast, and
perform beam matching processing with the second terminal device to determine a beam to be used before data transmission.

35-46. (canceled)
